(19) United States
(12) Patent Application Publication
(10) Pub. No.: US 2016/0055877 A1
(43) Pub. Date: Feb. 25, 2016

(54) BLU-RAY DISC FROM RECYCLED DISC MANUFACTURING MATERIALS AND A METHOD OF MANUFACTURING THE SAME

(71) Applicant: THOMSON LICENSING, Issy-les-Moulineaux (FR)

(72) Inventor: John Matthew TOWN, Ojai, CA (US)

(21) Appl. No.: 14/778,731

(22) PCT Filed: May 31, 2013
(86) PCT No.: PCT/US2013/043689

§ 371 Date: Sep. 21, 2015

(51) Int. Cl. G11B 7/24067; G11B 7/24073; G11B 7/26; G11B 7/24053

(52) U.S. Cl. CPC G11B 7/24067; G11B 7/24053; G11B 7/24073; G11B 7/266

(57) ABSTRACT

A Blu-ray ray optical disc comprises a base substrate of recycled polycarbonate molded without a data layer on a first surface. The disc further includes a first transmission stack having (a) a data region layer having a first surface adjoining the first surface of the base substrate and a second, opposite surface embossed with data, and (b) a layer of metallization overlying the second surface of the data layer. Lastly, a protective layer overlies the region of metallization of the first transmission stack.

### TECHNICAL FIELD

This invention relates to optical discs, and more particularly to Blu-ray optical discs.

### BACKGROUND ART

Optical discs have emerged as a convenient mechanism for storing large amounts of data, and particularly, video data. Indeed, optical discs remain the media of choice for storing movies for consumer sale and rental. The Blu-ray standard has recently emerged as the preferred standard for high-definition optical discs. A single-layer Blu-ray disc comprises a molded polycarbonate base substrate with a recorded layer on one surface covered by a single transmission stack that includes a metal layer, a clear resin cover layer, and a protective resin layer overlaying the cover layer. The protective layer provides the entrance surface for the optical beam ultimately directed at the recorded layer to read the data carried thereby. (In addition to the single-layer Blu-ray disc, there also exists a dual-layer Blu-ray disc comprised of a base substrate carrying a first data layer (Layer-0) covered by a reflective metal layer which in turn is covered by a spacer-layer of clear resin in which a second data layer (Layer-1) is embossed; the Layer-1 data is covered by a semi-reflective metal layer and a clear resin cover layer and finally a protective resin layer. First and second transmission stacks (i.e., transmission stacks 0 and 1) are formed by the optical path of the reading laser to the respective data layers (i.e. Layer-0 and Layer-1)

In practice, the base substrate in both single-layer and dual-layer Blu-ray discs comprises polycarbonate and accounts for much of the material cost of the disc. During manufacture of Blu-ray discs, wasted polycarbonate material results from sprues discarded after each molding cycle plus start-up scrap and purging material associated with the injection molding machine reaching temperature and steady-state operating conditions. Presently, optical disc manufacturers re-cycle scrap/wasted polycarbonate such as molding sprues by re-introducing such sprues into the feedstock material for the Layer-1 portion of a DVD, which does not form part of the optical readout path

Presently, most optical disc manufacturers limit their recycling strictly to scrap molding sprues; upon discarding of the molding sprue, such sprues are immediately ground and re-introduced into the molding process feed material supply by custom equipment designed to minimize exposure and contamination of material. This continuous dynamic process effectively ensures that the percentage of sprue-regrind material introduced into a DVD Layer-1 substrate remains below approximately 10%. There currently exist strict requirements for the cleanliness and percentage of recycled material used in making the Layer 1 portion of DVDs because the Layer-1 disc has molded digital data with strict requirements for material purity. Typically, much of the wasted/scrapped polycarbonate produced during CD/DVD and Blu-ray disc manufacture, other than sprues, lacks the necessary cleanliness for re-cycling in the disc manufacturing process. Indeed, even introducing small amounts of wasted/scrapped polycarbonate other than molded sprues can adversely affect the production of the DVD layer-1 substrates. The unusable scrapped polycarbonate is typically sold at a fraction of the cost of virgin material. While other cheaper materials could be substituted, polycarbonate has the desired mechanical and optical properties required to minimize impact on the manufacturing process.

Thus, a need exists for an optical disc production process that can make greater use of recycled polycarbonate.

### BRIEF SUMMARY OF THE INVENTION

Briefly, in accordance with a preferred embodiment of the present principles, a Blu-ray optical disc comprises a base substrate of recycled polycarbonate molded with or without a data layer on a first surface; such data layer if present shall not be readable by a player and exists to minimize impact on the manufacturing equipment and process. The disc further includes a first transmission stack having (a) a data region having a first surface adjoining the first surface of the base substrate and a second, opposite surface embossed with data, and (b) a layer of metallization overlying the second surface of the data layer covered by a clear resin cover layer and protective resin layer.

The Blu-ray disc of the present principles makes use of the fact that Blu-ray discs can comprise either single-layer or dual-layer and that the polycarbonate disc substrate does not have strict optical property requirements because the substrate does not form part of the optical path during playback. Rather than require virgin polycarbonate, the Blu-ray disc of the present principles makes use of a substrate molded from recycled polycarbonate material. The molded substrate of recycled polycarbonate does not have readable data molded thereon in contrast to the substrate of a conventional Blu-ray disc. Instead, the Blu-ray disc of the present principles invention makes use of the dual-layer embossing process integrated into today's Blu-ray manufacturing lines, which allows for creation of a separate first data layer that serves to isolate the substrate, thereby allowing the use of recycled (low grade) polycarbonate material typically deemed unfit for optical disc substrates. Since the Blu-ray disc of the present principles has no readable molded data associated with it, it further allows the use of damaged or non-optimal mold faces that are not deemed suitable for molding data on Blu-ray discs. The utility of the Blu-ray disc of the present principles is to maximize polycarbonate yield which is typically a key process performance indicator for disc manufacturers.

### BRIEF SUMMARY OF THE DRAWINGS

FIG. 1 depicts a prior art dual-layer Blu-ray disc in cross-section along with an accompanying chart describing the properties of the disc layers; and

FIG. 2 depicts a single layer Blu-ray disc in cross section in accordance with a preferred embodiment of the present principles, along with an accompanying chart describing the properties of the disc layers.

### DETAILED DESCRIPTION

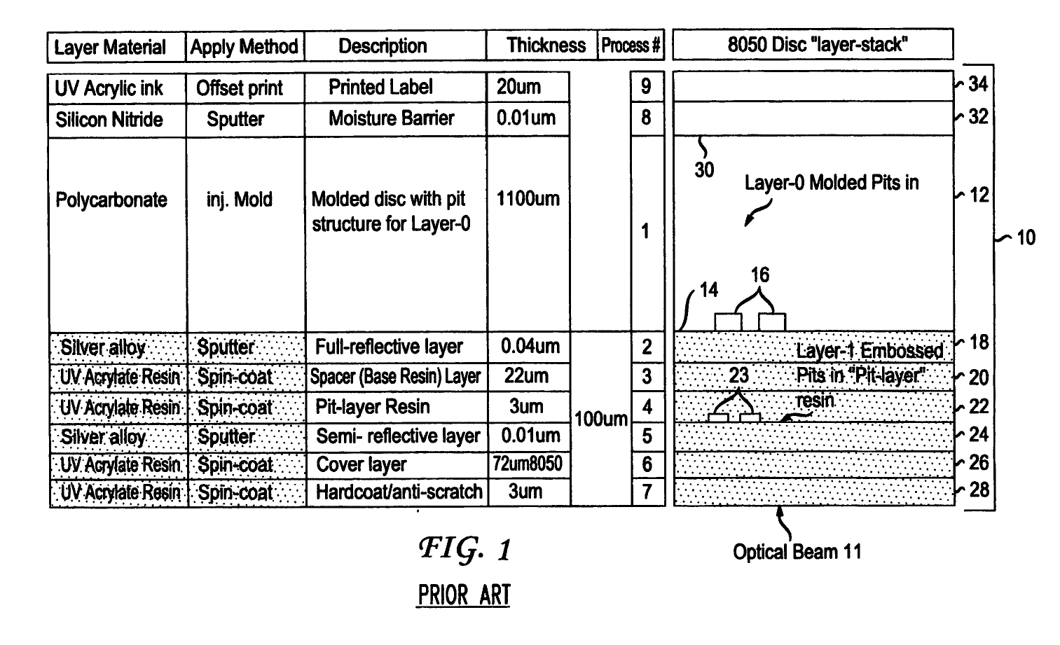

FIG. 1 depicts a prior art dual-layer Blu-ray disc 10 in cross-section along with an accompanying chart describing the properties of the disc layers. Within the industry, the term “BD50” often serves to identify this type of disc. The Blu-ray disc 10 of FIG. 1 includes a base substrate 12 of virgin polycarbonate produced through a well-known molding process so that a first surface 14 of the substrate has molded pits 16 forming a first set of data on the disc 10 for reading via an optical beam 11. After molding, the base substrate 12 undergoes a sputtering process to deposit a fully reflective layer metallization 18 onto the surface 14 of the substrate. Typically, a silver alloy constitutes the preferred material for sputtering onto the surface 14 of the substrate 12, although other metals or metal alloys could find application for this purpose, taking into account a variety of factors including but not limited to cost, reflectivity, and reliability.

The metallization layer 18 has an overlying layer of resin 20, typically applied by spin coating. This resin layer 20 often bears the designation “base or spacer layer.” A layer of resin 22, typically applied through spin coating and bearing the designation “pit layer”, overlies the resin layer 20. The resin layer 22 undergoes embossing to create pits 23 that form a second set of data on the disc 10. Just as the first surface 14, with its molded pits 16, has an overlying metallization layer 18, the resin layer 22, with its embossed pits 23, also has an overlying layer of metallization 24, typically formed by sputtering a silver alloy. The metallization layer 24 exhibits at least partial reflectivity as compared to the full reflectivity exhibited by the metallization layer 18.

The metallization layer 24 has an overlying resin layer 26 applied through spin coating to create a cover layer. The resin layer 26 itself has an overlying resin layer 28, also typically applied through spin coating, to provide a hard coating to resist scratches.

The base substrate 12 has a second surface 30 opposite the surface 14 so as to lie outside the path of the optical beam 11. The surface 30 of the substrate 12 has an overlying layer 32, typically formed by sputtering an inorganic moisture barrier such as SiN. The layer 32 typically carries a layer of ink 34 formed by offset printing or silk screening for example to create a label for the purpose of identifying the disc 10.

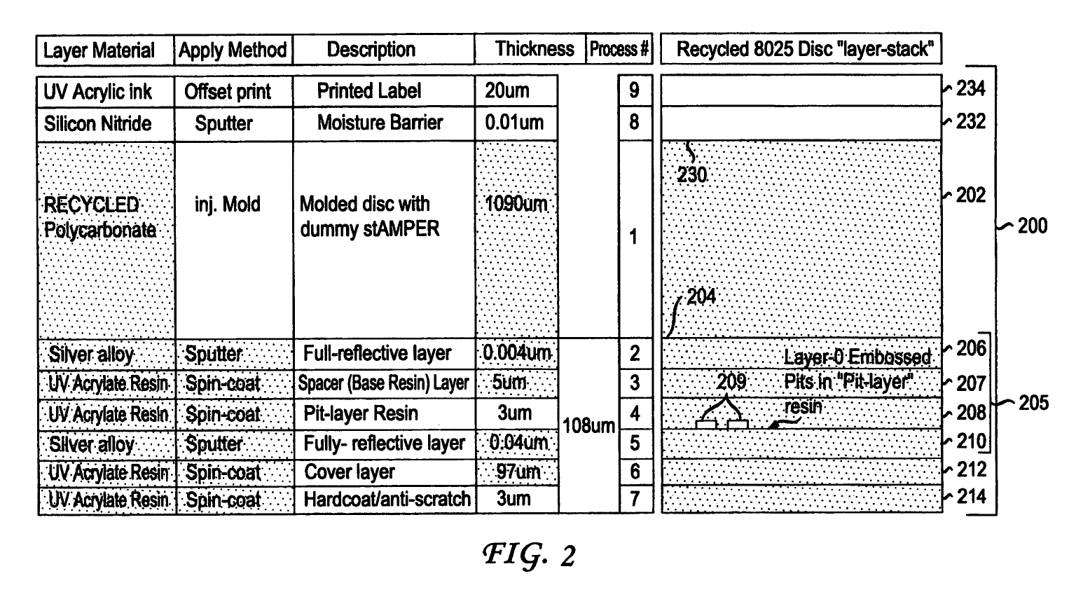

FIG. 2 depicts a single layer Blu-ray disc 200 in cross section in accordance with a preferred embodiment of the present principles, along with an accompanying chart describing the properties of the disc layers. The Blu-ray disc 200 of FIG. 2 includes a base substrate 202 of recycled polycarbonate. To make the base substrate 202, scrap/wasted polycarbonate is first ground up into pellets approximately the same size as virgin polycarbonate pellets of the type normally use in the molding of the base substrate for conventional dual-layer Blu-ray discs. During the grinding process, contamination, impurities and fine particles are removed. These recycled polycarbonate pellets serve as the raw material during the molding of the base substrate 202 using the conventional molding techniques/machinery used to make substrates for conventional Blu-ray discs. Thus, manufacturing the base substrate 202 of the Blu-ray disc 200 from recycled polycarbonate requires no special techniques and/or machines.

Like the Blu-ray disc 10 of FIG. 1 which has a base substrate 12 produced through a molding process, the Blu-ray disc 200 of the present principles likewise has a base substrate 202 also produced through molding. Indeed, the same kind of molding machine that produces the base substrate 12 for the Blu-ray disc 10 of FIG. 1 can produce the base substrate 202 for the Blu-ray disc 200 of FIG. 2, with the following modification. During the molding of the base substrate 12 of the Blu-ray disc 10 of FIG. 1, the substrate surface 14 undergoes molding typically by a nickel stamper to create the pits 16 forming the first data set on the disc. In contrast, during the molding of the base substrate 202 of the Blu-ray disc 200 of FIG. 2, the base substrate surface 204 will undergo molding with a dummy plain or textured or data stamper that may contain pits but such pits are not be readable on the final disc. In other words, unlike the Blu-ray disc 10 of FIG. 1 whose substrate carries data, the substrate 202 of the Blu-ray disc 200 of FIG. 2 carries no data that will be ultimately readable in the finished disc.

Since the base substrate 202 of the Blu-ray disc 200 carries no data, molding the substrate surface 204 with a dummy stamper may seem unnecessary. However, present day Blu-ray manufacturing lines carry out molding as a necessary operation. By making use of a dummy stamper with typical Blu-ray pit structure, production of the Blu-ray disc 200 can occur using present-day Blu-ray manufacturing equipment with little modification.

Instead of relying on the substrate 202 to carry data, as in the case of a conventional Blu-ray disc, the Blu-ray 200 of the present principles makes use a transmission stack 205, similar to the transmission stack 1 in a conventional dual-layer Blu-ray disc, for carrying data isolated from the substrate 202. The transmission stack 205 may optionally comprise a first layer 206 of a partially-reflective material, such as a silver alloy or aluminum, sputtered onto the base substrate surface 204 to aid in coverage of a base or spacer resin layer 207 typically spin coated to overlie the metallization layer 206. In comparison to the prior-art dual-layer Blu-ray disc 10 of FIG. 1, the resin layer 207 corresponds to the 20 base layer of the Blu-ray disc 10. Indeed, the resin layer 207 can be produced in the same manner using present day Blu-ray production equipment. The resin layer 207 has an overlying resin layer 208 typically formed by spin coating corresponding to the pit layer 22 of Blu-ray disc 10. The layer 208 undergoes embossing to create pits 209 that comprise the Layer-0 or first data set carried by the Blu-ray disc 200 of the present principles. Typically, the embossing of the layer 208 occurs in the same manner using equipment similar to that for embossing the pits 23 on the resin layer 22 of the Blu-ray disc 10 of FIG. 1.

The resin layer 208 has an overlying layer 210 of reflective metallization, typically formed thereon by sputtering a silver alloy corresponding to metal layer 18 of Blu-ray disc 10. The metallization layer 210 has an overlying resin layer 212 applied through spin coating to create a cover layer. The resin layer 212 itself has an overlying resin layer 214 also typically form through spin coating, to provide a hard coating to resist scratches. The layers 212 and 214 are typically applied through spin coating using techniques similar to those for applying the layers 26 and 28 on the Blu-ray disc 10 of FIG. 1.

The base substrate 202 of the Blu-ray disc 200 of FIG. 2 has a second surface 230 30 opposite the surface 204 so as to lie outside the path of an optical beam 231 for reading the data carried by the disc. The surface 230 of the substrate 202 has an overlying acrylic layer 232, typically formed by spin coating to provide a moisture barrier. The layer 232 typically carries a layer of ink 234 formed by offset printing or silk screening for example to create a label for the purpose of identifying the disc 200.

The overall process for making the Blu-ray disc 200 of FIG. 2 comprises the following steps:

1. Grind and granulate scrap polycarbonate material to the approximate pellet size of virgin polycarbonate material. Eliminate fine particles and metal contaminants by filtering/blowing and magnets etc.

2. Dry ground/pelletized recycled material to same dew point as virgin material.

3. Apply dummy stamper (zero data) to molding machine and mold the substrates 202.

4. Apply BD25 program stamper to Blu-ray line embossing unit.

5. Adjust Blu-ray replication line process parameters as follows:

a. Apply very thin metal layer 206 to aid resin coverage for layer 207 (approximately 3-5 nm to provide resin coating dynamics with no reflectivity requirement)

b. Reduce first resin layer (base resin layer) from typical 22-micron thickness to as low as 5 micron. This thickness can be varied to optimize yield and material usage.

c. Apply standard second resin layer 208 of a thickness (pit resin) 3-5 micron

d. Emboss program using typical embossing process parameters.

e. Create the layer 210 by metallizing the resin layer 208 with a typical Layer-0 silver thickness 30-40 nm.

f. Adjust dual-layer Blu-ray cover layer 212 thickness (3^{rd} resin layer) from 72 microns to 97 microns.

g. Add final hardcoat layer 214 (4^{th} resin layer) using normal process.

h. Adjust mold temperature differential to give desired radial skew/tilt of finished disc.

The foregoing describes single-layer Blu-ray disc manufactured from recycled polycarbonate material. As discussed manufacture of the recycled polycarbonate Blu-ray disc of the present principles can occur using the same techniques and machines as used to make conventional dual-layer Blu-ray discs.

While the recycled polycarbonate Blu-ray disc of the present principles has been described in terms of a single-layer disc, a dual layer recycled polycarbonate disc could be obtained by adding a second transmission stack (not shown) onto the transmission stack 205. Adding such a second transmission stack would require a different process than the current process used for conventional dual-layer Blu-ray discs.

1. A Blu-ray optical disc, comprising:
a base substrate of low grade polycarbonate molded with a dummy layer on a first surface;
a first transmission stack including,
a data region having a first surface adjoining the first surface of the base substrate and a second, opposite surface embossed with data;
a layer of metallization overlying the second surface of the data region; and
a clear cover layer and protective layer overlying the region of metallization of the first transmission stack.

2. The Blu-ray disc according to claim 1 wherein the data region comprises:
a layer of metallization on the adjoining the first surface of the base substrate;
a spacer layer overlying the metallization layer; and
a pit layer overlying the spacer layer, the pit layer being embossed with pits.

3. The Blu-ray disc according to claim 2 wherein the layer of metallization on the adjoining the first surface of the base substrate comprises a silver alloy or aluminum.

4. The Blu-ray disc according to claim 1 wherein the layer of metallization overlying the second surface of the data region comprises a silver alloy or aluminum.

5. The Blu-ray disc of claim 1 further including a second transmission stack interposed between the first transmission stack and the protective layer.

6. The Blu-ray disc according to claim 5 wherein the second transmission stack comprises:
a second data region;
a layer of metallization overlying the second data region.

7. A method of manufacturing a Blu-ray disc, comprising the steps of:
molding a base substrate of recycled polycarbonate;
embossing a first surface of the base substrate with a dummy stamper having no data;
forming a first transmission stack onto the first surface of the base substrate, the first transmission stack including,
a data region having a first surface adjoining the first surface of the base substrate and a second, opposite surface embossed with data;
a layer of metallization overlying the second surface of the data region; and
applying a protective layer to overly the region of metallization of the first transmission stack.

8. The method according to claim 7 wherein the molding step includes the steps of:
grinding and granulating scrap polycarbonate material to a predetermined pellet size; and
substantially eliminating fine particles and metal and other contaminants from the ground and granulated scrap polycarbonate material.

9. The method according to claim 7 wherein the first data region is formed by the steps of:
sputtering a metallic layer onto the first surface of the base substrate;
spin-coating resin onto the metallic layer to form a spacer layer;
spin coating resin onto the spacer layer to create a pit layer; and
embossing the pit layer with pits to form a data set.

11. The method according to claim 7 wherein the metallization layer formed over the second surface of the data regions comprises the step of sputtering a metal alloy.

12. The method according to claim 11 wherein the metallic alloy comprises a silver alloy or aluminum.

13. The method according to claim 7 wherein a protective cover is applied by the steps of:
spin-coating a first resin layer onto the layer of metallization overlying the second surface of the data region; and
spin coating a second resin layer onto the first resin layer.

14. The method according to claim 7 further including the step of forming a second transmission stack over the first transmission stack.
